(19) United States
(12) Patent Application Publication
(10) Pub. No.: US 2010/0330864 A1
(43) Pub. Date: Dec. 30, 2010

(54) MANUFACTURING METHOD OF PLASMA DISPLAY PANEL

(76) Inventors: Haruhiro Yuki, Osaka (JP); Hideki Yamashita, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/867,938

(22) PCT Filed: Jun. 12, 2009
(86) PCT No.: PCT/JP2009/002664

§ 371 Date: Aug. 17, 2010

(30) Foreign Application Priority Data
Jun. 26, 2008 (JP) 2008-166811

(51) Int. Cl. H01J 9/02

(52) U.S. Cl. 445/24

(57) ABSTRACT

In the manufacturing method of the plasma display panel, the protective layer of the front plate has a base film evaporated on a dielectric layer, and this base film is surface-treated, and an ink film formed of agglomerated particles agglomerating a plurality of crystal particles of metal oxide and an organic solvent is formed, and after vacuum drying, the organic solvent is removed from the ink film, and thereby the plurality of agglomerated particles are bonded and formed on the base film.

### TECHNICAL FIELD

The present invention relates to a manufacturing method of a plasma display panel to be used in a display device or the like.

### BACKGROUND ART

A plasma display panel (hereinafter called a PDP) is capable of realizing a high definition and a large screen, and is commercially produced as a 65-inch class television of the like. Recently, the PDP is advanced in application in high definition television of more than double number of scan lines as compared with the conventional NTSC system, and in consideration of the environmental problems, the PDP free from lead content is demanded.

Basically, the PDP is composed of a front plate and a rear plate. The front plate includes a glass substrate, a display electrode, a dielectric layer, and a protective layer. The display electrode is composed of a striped transparent electrode and a bus electrode formed on one principal surface of the glass substrate. The dielectric layer covers the display electrode, and functions as a capacitor. The protective layer is made of magnesium oxide (MgO) being formed on the dielectric layer. The rear plate includes a glass substrate, an address electrode, a base dielectric layer, a barrier rib, and a phosphor layer. The address electrode is formed in stripes on one principal surface of the glass substrate. The base dielectric layer covers the address electrode. The barrier rib is formed on the base dielectric layer. The phosphor layer is formed between barrier ribs, and emits light in red color, green color, and blue color.

The front plate and the rear plate are hermetically sealed having the electrode forming side formed oppositely to each other, and the discharge space closed by the barrier ribs is packed with Ne—Xe discharge gas at a pressure of 400 Torr to 600 Torr. The PDP discharges by applying a video signal voltage selectively to the display electrode, and the ultraviolet ray generated by this discharge excites each color phosphor layer to emit light in red color, green color, and blue color, thereby realizing a color image display. Such PDP is disclosed, for example, in patent document 1.

In such PDP, the role of the protective layer formed on the dielectric layer of the front plate is to protect the dielectric layer from ion impact generated by discharge, and to release the initial electrons for generating an address discharge. Protection of the dielectric layer from ion impact is very important for preventing elevation of discharge voltage. Similarly, releasing of the initial electrons for generating an address discharge is very important for preventing address discharge error which may cause flickering of the image.

Recently, the television is much advanced in high definition, and the market is demanding PDP products of low cost, low power consumption, and full high definition (HD) (1920×1080 pixels: progressive display) of high luminance. The electron discharge characteristic from the protective layer determines the image quality of the PDP, and controlling of electron discharge characteristic is extremely important.

### PRIOR ART LITERATURE

### Patent Document

Patent document 1: Japanese Patent Application Unexamined Publication No. 2003-128430

### SUMMARY OF THE INVENTION

A manufacturing method of a plasma display panel of the present invention includes: forming a front plate including a dielectric layer formed on a substrate so as to cover a display electrode, and a protective layer formed on the dielectric layer; and forming a rear plate including address electrodes disposed oppositely to form a discharge space on the front plate and in directions intersecting with the display electrode, and barrier ribs for dividing the discharge space, wherein the protective layer of the front plate has a base film evaporated on the dielectric layer, and the base film is surface-treated, and an ink film composed of a plurality of crystal particles of metal oxide and an organic solvent is formed, and the organic solvent is removed from the ink film by vacuum drying, and a plurality of crystal particles are bonded on the base film.

### BRIEF DESCRIPTION OF DRAWINGS

FIG. 1 is a perspective view of structure of a PDP in a preferred embodiment of the present invention.

FIG. 2 is a sectional view of structure of a front plate of the PDP in the preferred embodiment of the present invention.

FIG. 3 is an explanatory diagram of agglomerated particles of the PDP in the preferred embodiment of the present invention.

FIG. 4 is a diagram showing forming steps of a protective layer in a manufacturing method of the PDP of the present invention.

### PREFERRED EMBODIMENTS FOR CARRYING OUT THE INVENTION

For manufacturing of a PDP having two contradictory characteristics, that is, high electron releasing capacity, and small damping rate of electric charge as memory function, that is, high charge retaining characteristic, it is important to distribute agglomerated particles agglomerating a plurality of crystal particles made of metal oxide uniformly within the display area, and to manufacture at low cost.

The present invention is devised in the light of this problem, and it is hence a primary object thereof to manufacture a PDP having a display performance of high definition and high luminance, and low in power consumption, at low cost.

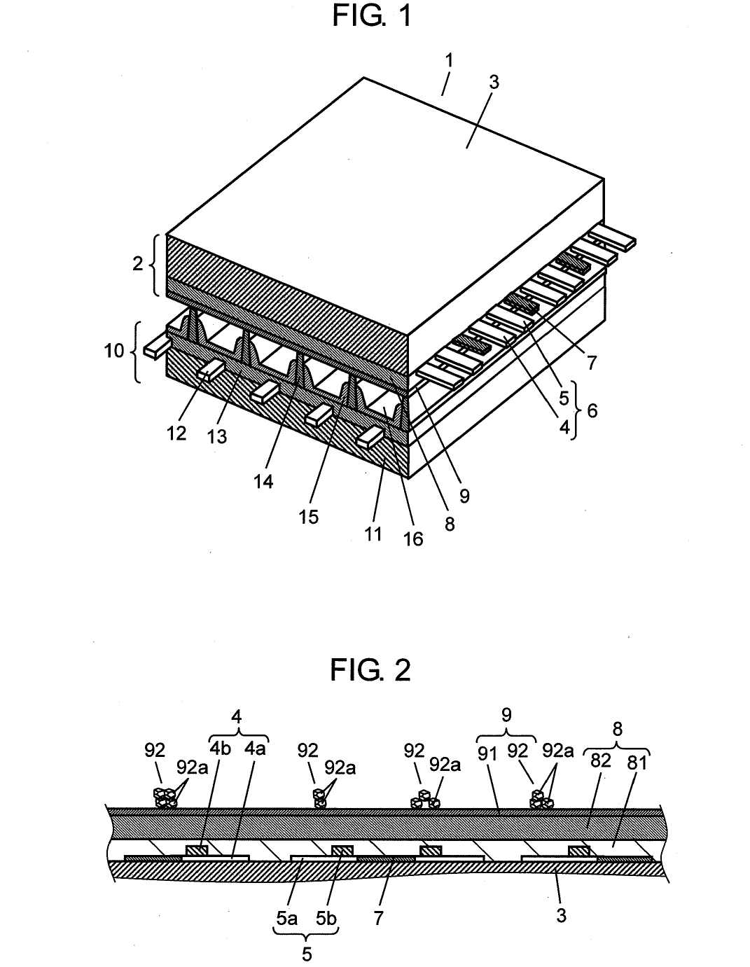

A preferred embodiment of the PDP of the present invention is specifically described below while referring to the accompanying drawings. FIG. 1 is a perspective view of structure of a PDP realized in a preferred embodiment of the present invention. The basic structure of the PDP is same as that of a general AC surface discharge type PDP. As shown in FIG. 1, PDP 1 includes front plate 2 formed of front glass substrate 3, and rear plate 10 formed of rear glass substrate 11, disposed oppositely to each other, in which the outer circumference is hermetically sealed by a sealing member of glass frit. Inside of the sealed PDP 1, discharge space 16 is packed with a discharge gas of Ne and Xe, at a pressure of 400 Torr to 600 Torr.

On front glass substrate 3 of front plate 2, a pair of band-like display electrodes 6 composed of scan electrode 4 and sustain electrode 5 and black stripes (light shielding layers) 7 are disposed in parallel to each other in a plurality of rows. On front glass substrate 3, dielectric layer 8 functioning as a capacitor is formed for covering display electrodes 6 and light shielding layers 7. Further on the surface, protective layer 9 composed of magnesium oxide (MgO) or the like is formed.

On rear glass substrate 11 of rear plate 10, a plurality of band-like address electrodes 12 are disposed in parallel to each other, in a direction orthogonal to scan electrodes 4 and sustain electrodes 5 of front plate 2, and they are covered with base dielectric layer 13. On base dielectric layer 13 between address electrodes 12, barrier ribs 14 of a specified height for dividing discharge space 16 are formed. In the grooves between barrier ribs 14, phosphor layers 15 for emitting light in red color, green color and blue color by ultraviolet ray are sequentially applied and formed in every one of address electrodes 12. Discharge cells are formed at intersecting positions of scan electrodes 4, sustain electrodes 5, and address electrodes 12, and the discharge cells having red, green and blue phosphor layers 15 arranged in a direction of display electrodes 6 become pixels for displaying a color image.

FIG. 2 is a sectional view of structure of front plate 2 of PDP 1 realized in a preferred embodiment of the present invention, and FIG. 2 is a view of FIG. 1 inverted upside down. Patterns of display electrodes 6 and light shielding layers 7 formed of scan electrodes 4 and sustain electrodes 5 are formed. Scan electrodes 4 are formed of transparent electrodes 4a made of indium tin oxide (ITO) or tin oxide (SnO₂), and metal bus electrodes 4b formed on transparent electrodes 4a. Sustain electrodes 5 are formed of transparent electrodes 5a made of indium tin oxide (ITO) or tin oxide (SnO₂, and metal bus electrodes 5b formed on transparent electrodes 5a. Dielectric layer 8 is formed of two layers, that is, first dielectric layer 81 and second dielectric layer 82. Protective layer 9 is formed on second dielectric layer 82. First dielectric layer 81 is formed to cover all of transparent layers 4a, 5a, metal bus electrodes 4b, 5b, and light shielding layers 7 formed on front glass substrate 3. Second dielectric layer 82 is formed on first dielectric layer 81.

Protective layer 9 has base film 91 made of MgO containing Al as impurities, formed on dielectric layer 8, and on this base film 91, agglomerated particles 92 agglomerating a plurality of crystal particles 92a of metal oxide MgO are scattered discretely, and are distributed almost uniformly on the entire surface.

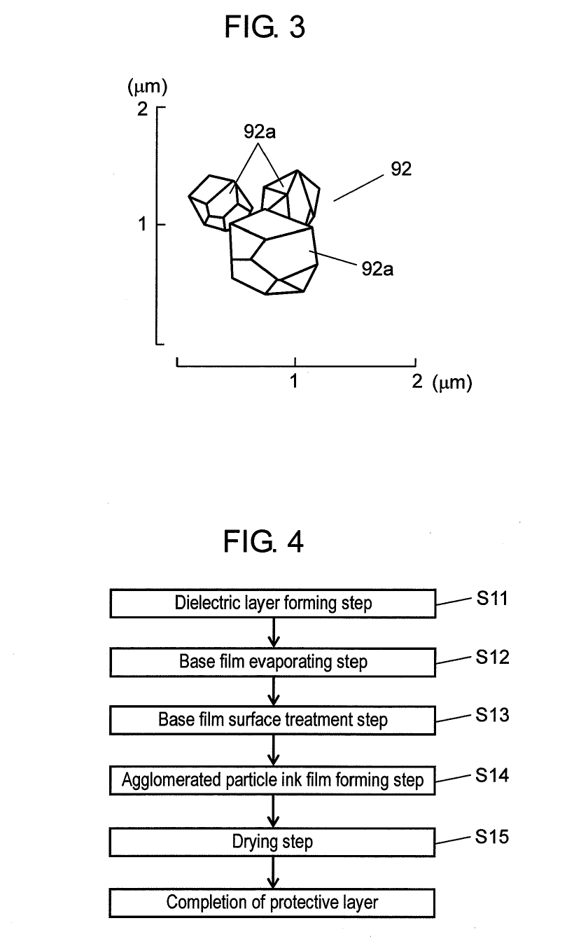

FIG. 3 is a sectional view showing a structure of the front plate of the PDP in the preferred embodiment of the present invention. Agglomerated particles 92, as shown in FIG. 3, are formed as an agglomerating or necking group of crystal particles 92a of a specified primary particle size. They are not a bonded body having a large binding force as a solid body, but a plurality of primary particles are gathered as a group by static electricity or van der Waals force, being bonded to such a degree to become primary particles in part or in whole, by external stimulation by ultrasound or the like. The particle size of agglomerated particles 92 is about 1 μm, and crystal particles 92 are preferred to be polyhedral shapes having 14 facets, 12 facets, or 7 or more facets.

FIG. 4 shows the manufacturing method of the PDP of the present invention, showing steps of forming the protective layer. As a preferred embodiment of the present invention, manufacturing steps of protective film 9 are explained. As shown in FIG. 4, dielectric layer 8 of a laminated structure of first dielectric layer 81 and second dielectric layer 82 is formed in dielectric layer forming step S11. Then in next base layer evaporating step S12, by vacuum deposition method using a sinter of MgO containing Al as raw material, base layer 91 composed of MgO is formed on second dielectric layer 82 of dielectric layer 8.

In succession, in base film surface treatment step S13, an excimer UV lamp of center wavelength 172 nm is emitted to the substrate surface by an integrated irradiation dose of 80 mJ or more. For example, using an excimer UV lamp of output of 40 mW, the lamp-substrate distance is set at 3 mm, by adjusting to low levels of oxygen amount and moisture amount in the treatment atmosphere by N2 flow, damping of UV light (ultraviolet light) can be suppressed. By emission time of about 6 seconds, an integrated irradiation dose of 150 mJ will be obtained on the substrate surface. By UV irradiation (ultraviolet irradiation), the surface of base film 91 of MgO is cleaned by decomposing and removing oil contaminating stains suspended in the atmosphere. However, the cleaned surface is contaminated again with the lapse of time, and base film surface treatment step S13 is preferred to be executed immediately before agglomerated particle ink layer forming step S14.

The ink used in agglomerated particle ink layer forming step S14 is composed of agglomerated particles 92 agglomerating a plurality of MgO crystal particles 92a of metal oxide, and a solvent, and resin binder is not contained, and hence the viscosity is very low. Agglomerated particles 92 may be obtained by a method of heating MgO precursor, such as magnesium carbonate or magnesium hydroxide, and a plurality of primary particles are gathered into a bonded body by a relative weak force of static electricity or van der Waals force. By controlling the condition of ultrasonic dispersion or the like in the ink forming process, the average particle size may be uniformly adjusted in a range of 0.9 μm to 2 μm. The solvent has a high affinity for base film 91 of MgO or agglomerated particles 92, and it is easy to evaporate and remove in the next step of drying step S15, and a solvent of relatively high vapor pressure of about scores of Pa at ordinary temperature is suited. Preferred examples of the solvent include methyl methoxy butanol, terpineol, propylene glycol, benzyl alcohol, and other organic solvents alone, or mixed solvents of them. The viscosity of the ink containing such solvent ranges from several units of mPaS to scores of units of mPaS.

Means for applying such ink of agglomerated particles of very low viscosity on base film 91 in a specified film thickness includes, for example, a slit coating method. By the slit coating method, an ink film of average film thickness of 8 μm to 20 μm is uniformly formed in a specified area. After the ink film is formed, the substrate is immediately transferred to drying step S15, and is dried at reduced pressure. The ink film is rapidly dried in the vacuum chamber within scores of seconds, and there is no convection of ink liquid often observed in the heating and drying process. As a result, agglomerated particles 92 are uniformly bonded on the surface of base film 91 without being deviated.

After such UV treatment (ultraviolet treatment) of base film 91, a low-viscosity ink free from resin binder is applied by slit coating, and is dried in vacuum, so that agglomerated particles 92 may be bonded uniformly. Accordingly, at a low facility cost, a panel of high quality may be produced.

To realize the PDP of display performance of high definition and high luminance, and low power consumption, as the characteristics of the protective film, two contradictory characteristics must be satisfied, that is, high electron releasing capacity, and small damping rate of electric charge as memory function, that is, high charge retaining characteristic. For this purpose, it is important to distribute agglomerated particles agglomerating a plurality of crystal particles made of metal oxide uniformly on the base film of MgO, for example, containing impurities such as Al or Si, evaporated on the dielectric layer, and to form at low cost.

As clear from the explanation herein, according to the manufacturing method of the present invention, a plurality of agglomerated particles can be distributed on the base film uniformly on the entire surface, and can be formed at low cost, and a PDP having a display performance of high definition and high luminance, and low in power consumption can be realized.

### INDUSTRIAL APPLICABILITY

As described herein, the present invention is very useful for realizing a PDP having a display performance of high definition and high luminance, and low in power consumption.

### DESCRIPTION OF REFERENCE MARKS

1 PDP
2 Front plate
3 Front glass substrate
4 Scan electrode
4a, 5a Transparent electrode
4b, 5b Metal bus electrode
5 Sustain electrode
6 Display electrode
7 Black stripe (light shielding layer)
8 Dielectric layer
9 Protective layer
10 Rear plate
11 Rear glass substrate
12 Address electrode
13 Base dielectric layer
14 Barrier rib
15 Phosphor layer
16 Discharge space
81 First dielectric layer
82 Second dielectric layer
91 Base film
92 Agglomerated particle
92a Crystal particle

1. A manufacturing method of a plasma display panel comprising:
forming a front plate including a dielectric layer formed on a substrate so as to cover a display electrode, and a protective layer formed on the dielectric layer; and
forming a rear plate including address electrodes disposed oppositely to form a discharge space on the front plate and in directions intersecting with the display electrode, and barrier ribs for dividing the discharge space,
wherein the protective layer has a base film evaporated on the dielectric layer, and the base film is surface-treated,
an ink film composed of a plurality of crystal particles of metal oxide and an organic solvent is formed, and
the organic solvent is removed from the ink film by drying, and a plurality of crystal particles are bonded on the base film.

2. The manufacturing method of the plasma display panel of claim 1, wherein the surface treatment of the base film is a treatment by ultraviolet irradiation.

3. The manufacturing method of the plasma display panel of claim 2, wherein the wavelength of ultraviolet rays to be emitted by the ultraviolet irradiation is 185 nm or less.

4. The manufacturing method of the plasma display panel of claim 2, wherein the dose of ultraviolet rays to be emitted by the ultraviolet irradiation is 50 mJ or more to 300 mJ or less.
